(19) United States
(12) Patent Application Publication
(10) Pub. No.: US 2026/0085085 A1
(43) Pub. Date: Mar. 26, 2026

(54) Bimetallic Metal-Organic Framework Electrode Material Based on Deep Eutectic Solvent, Preparation Method Thereof, and Application Thereof

(71) Applicant: China Agricultural University, Beijing (CN)

(72) Inventors: En XIE, Beijing (CN); Yu HAN, Beijing (CN); Yunkai LI, Beijing (CN); Zhanming TAN, Beijing (CN); Peilin HAN, Beijing (CN); Mengqi JIANG, Beijing (CN)

(73) Assignee: China Agricultural University, Beijing (CN)

(21) Appl. No.: 19/409,619

(22) Filed: Dec. 4, 2025

(30) Foreign Application Priority Data
May 14, 2025 (CN) 202510620721.0

(51) Int. Cl. C07F 15/04; C02F 1/461; C02F 1/469

(52) U.S. Cl. CPC C07F 15/04; C02F 1/46114; C02F 1/4691; C02F 2001/46133; C02F 2201/46115

(57) ABSTRACT

The present invention relates to the field of water treatment technology, and specifically relates to a bimetallic organic framework electrode material based on a deep eutectic solvent. The electrode material is prepared by mixing a deep eutectic solvent with water, a soluble iron salt and a soluble nickel salt, dissolving by sonication, adding activated carbon powder and a dispersant, and then adding 2-methylimidazole to obtain an iron-nickel bimetallic organic framework activated carbon composite material. The iron-nickel bimetallic organic framework composite material is mixed with a conductive agent and a binder to obtain an electrode slurry, which is dried to obtain an electrode material. The present invention uses a deep eutectic solvent to generate an iron-nickel bimetallic composite carbon capacitive deionization electrode material, and applies it to a hybrid capacitive deionization device to achieve the removal of salt ions in water.

### TECHNICAL FIELD

The present invention relates to the field of water treatment technology, and more specifically, to a bimetallic metal-organic framework electrode material based on a deep eutectic solvent, as well as its preparation method and application.

### BACKGROUND

Capacitive Deionization (CDI) technology, as a novel brackish water desalination technology, is gradually becoming an effective alternative to traditional desalination methods due to its significant advantages such as environmental friendliness, low energy consumption, low cost, high regeneration efficiency, and no secondary pollution. CDI technology is based on the electric double layer physical adsorption theory, which drives charged ions in the solution to migrate towards the porous electrode and form an electric double layer adsorption by applying a directional electrostatic field. When the electrode adsorption approaches saturation, rapid ion desorption is achieved through potential reversal or short-circuit operation, forming a cyclical ion adsorption and desorption process.

In CDI systems, the specific surface area, conductivity, and ion transport channels of the electrode material are key factors determining the desalination performance. Metal-Organic Frameworks (MOFs), due to their unique topological structures, such as high specific surface area, tunable pore size system, and abundant metal active sites, have shown great potential in constructing efficient ion adsorption interfaces. In particular, bimetallic MOFs, through the synergistic effect of heterogeneous metal centers, can induce the formation of lattice defects, significantly increase the concentration of coordinatively unsaturated sites, and improve charge transfer efficiency through the bimetallic electronic coupling effect. When composited with carbon-based materials (such as activated carbon, graphene), bimetallic MOFs can maintain a hierarchical pore structure and form a chemical bonding interface with the carbon matrix, achieving dual-channel synergistic transport of electrons and ions.

In the prior art, the invention patent with publication number CN116177690A discloses a method for capacitive deionization to remove fluoride ions from water using a polypyrrole/bimetallic MOF/graphite composite electrode. This invention uses an organic solvent as a ligand solution, and the resulting electrode material has a low removal efficiency of fluoride ions in water, and the generation method is a high-temperature hydrothermal method, which has certain safety risks during the generation process.

### SUMMARY

In view of the deficiencies of the prior art, the object of the present invention is to provide a bimetallic metal-organic framework electrode material based on a deep eutectic solvent, a preparation method thereof, and an application thereof. The present invention uses a deep eutectic solvent to generate an iron-nickel bimetallic composite carbon capacitive deionization electrode material, and applies it to a hybrid capacitive deionization device to remove salt ions from water.

To solve the above technical problems, the present invention adopts the following technical solutions:

A method for preparing a bimetallic metal-organic framework electrode material based on a deep eutectic solvent, comprising the following steps:

Mixing a deep eutectic solvent with water to obtain a mixed solvent.

Using the mixed solvent containing the deep eutectic solvent and water as a ligand solution, adding a soluble iron salt and a soluble nickel salt to the mixed solvent, dissolving by ultrasonication, then adding activated carbon powder and a dispersant, mixing by ultrasonication, and then adding a 2-methylimidazole ligand to obtain an iron-nickel bimetallic metal-organic framework activated carbon composite material precursor solution.

Performing a water bath reaction on the iron-nickel bimetallic metal-organic framework activated carbon composite material precursor solution, and performing post-treatment on the water bath reaction product to obtain an iron-nickel bimetallic metal-organic framework activated carbon composite material.

Using the iron-nickel bimetallic metal-organic framework composite material as an electrode active material, mixing with a conductive agent and a binder to obtain an electrode slurry, coating the electrode slurry on an electrode plate, and drying to obtain an iron-nickel bimetallic metal-organic framework activated carbon composite electrode material.

In the preparation process of the iron-nickel bimetallic metal-organic framework activated carbon composite material, the present invention uses a mixed solvent of a deep eutectic solvent and water as a ligand solution. During the synthesis process, the deep eutectic solvent not only acts as a solvent, but also as a structure-directing agent. Components in the deep eutectic solvent, such as chloride ions and choline ions, can coordinate with metal ions and act as templates or ligands to guide pore formation, regulate the pore structure of MOFs, and enhance their adsorption and separation performance. Chloride ions in the deep eutectic solvent or ammonia generated by decomposition can act as structure-directing agents, affecting the coordination mode of metal nodes, thereby regulating the pore size and porosity, and achieving efficient removal of salt ions from water.

In a preferred embodiment of the present invention, the deep eutectic solvent is composed of a hydrogen bond acceptor and a hydrogen bond donor, the hydrogen bond acceptor is choline chloride, the hydrogen bond donor is urea, and the molar ratio of the hydrogen bond acceptor to the hydrogen bond donor is 1:1.5˜2.5.

In a preferred embodiment of the present invention, the volume ratio of the deep eutectic solvent to water is 20:3˜5.

In a preferred embodiment of the present invention, the usage ratio of iron element in the soluble iron salt, nickel element in the soluble nickel salt, and the mixed solvent is 1 mol:3 mol:46 mL˜50 mL.

In a preferred embodiment of the present invention, the usage ratio of the activated carbon powder to the mixed solvent is 1.5 g˜2.5 g:46 mL˜50 mL, and the mass fraction of the dispersant in the soluble iron salt and the soluble nickel salt is 15%˜25%.

In a preferred embodiment of the present invention, the water bath reaction temperature is 60° C.˜80° C., and the reaction time is 10 h˜12 h.

In a preferred embodiment of the present invention, the mass ratio of the iron-nickel bimetallic metal-organic framework activated carbon composite material to the conductive agent and the binder is 80˜90:5˜10:5˜10.

Another object of the present invention is to provide a bimetallic metal-organic framework electrode material based on a deep eutectic solvent, which is prepared by the preparation method according to any one of the preceding items.

A third object of the present invention is to provide an application of the above-mentioned bimetallic metal-organic framework electrode material based on a deep eutectic solvent in a hybrid capacitive deionization device, wherein the bimetallic metal-organic framework electrode material based on a deep eutectic solvent is applied to a hybrid capacitive deionization device to remove salt ions from water.

In a preferred embodiment of the present invention, asymmetric electrodes are assembled using a hybrid capacitive deionization module, the anode is the above-mentioned bimetallic metal-organic framework electrode material based on a deep eutectic solvent, the cathode is an activated carbon electrode, and a cation exchange membrane and an anion exchange membrane are arranged in front of the anode and cathode plates.

In the prior art, the electrode materials of the anode and cathode of the capacitive deionization device are the same, while the materials of the anode and cathode of the hybrid capacitive deionization device are different, which can better exert the adsorption capacity of different materials for anions and cations. In the present invention, the iron-nickel bimetallic metal-organic framework activated carbon composite material has a strong electroadsorption capacity for anions, but its adsorption capacity for cations is not as good as that of the activated carbon electrode. Therefore, using the composite material as an anode material to adsorb anions and using the activated carbon material as a cathode to adsorb cations is more conducive to the adsorption of salt ions.

Deep eutectic solvents (DESs), as emerging green solvents, exhibit significant advantages in the preparation of metal-organic framework (MOFs) materials. They are composed of hydrogen bond donors and acceptors, and have low toxicity, low volatility, and high thermal stability, which reduces environmental pollution and experimental safety risks. By adjusting the components, the physical and chemical properties can be regulated to form a unique hydrogen bond network, which affects the melting point, viscosity, and solubility of the solvent. In MOF synthesis, DESs not only act as solvents, but also as structure-directing agents, regulating the pore structure of MOFs and enhancing their adsorption and separation performance. In addition, DESs have readily available raw materials, low cost, simple operation, and good thermal and chemical stability, providing a stable environment for synthesis, thereby enabling large-scale synthesis of MOFs materials. These characteristics make DESs have broad application prospects in the synthesis of MOFs materials, and can bring more innovative possibilities and practical application value compared with traditional chemical solvents.

Compared with the prior art, the present invention has the following beneficial effects:

1. In the present invention, a deep eutectic solvent mixed with water is used as a mixed solvent, a soluble iron salt and a soluble nickel salt are added to the mixed solvent, and after ultrasonic dissolution, activated carbon powder and a dispersant are added, mixed by ultrasonication, and then 2-methylimidazole is added to obtain an iron-nickel bimetallic metal-organic framework activated carbon composite material precursor solution; the iron-nickel bimetallic metal-organic framework activated carbon composite material precursor solution is subjected to a water bath reaction to obtain an iron-nickel bimetallic metal-organic framework activated carbon composite material, which is then mixed with a conductive agent and a binder to obtain an electrode slurry, and the electrode slurry is coated on an electrode plate to obtain an iron-nickel bimetallic metal-organic framework activated carbon composite electrode material. In the preparation process of the iron-nickel bimetallic metal-organic framework activated carbon composite material, the present invention uses a mixed solvent of a deep eutectic solvent and water as a ligand solution. During the synthesis process, the deep eutectic solvent not only acts as a solvent, but also as a structure-directing agent. Components in the deep eutectic solvent, such as chloride ions and choline ions, can coordinate with metal ions and act as templates or ligands to guide pore formation, regulate the pore structure of MOFs, and enhance their adsorption and separation performance. Chloride ions in the deep eutectic solvent or ammonia generated by decomposition can act as structure-directing agents, affecting the coordination mode of metal nodes, thereby regulating the pore size and porosity, and achieving efficient removal of salt ions from water.

2. The raw materials of the deep eutectic solvent used in the present invention are readily available, low in cost, simple in operation, and have good thermal stability and chemical stability, providing a stable environment for synthesis, thereby enabling large-scale synthesis of iron-nickel bimetallic metal-organic framework activated carbon composite materials.

### BRIEF DESCRIPTION OF THE DRAWINGS

FIG. 1 is a schematic diagram of the module structure of the capacitive deionization technology of the present invention, wherein 1 is a glass plate, 2 is a silicone gasket, 3 is a current collector, 4 is an ion exchange membrane, 5 is a hollow silicone gasket, 6 is a plastic gasket, and 7 is an electrode coating.

FIG. 2 is a SEM image of the DES-MOF powder prepared in Example 1 of the present invention.

FIG. 3 is a comparison diagram of the decrease in salt solution concentration of the DES-MOF prepared in Example 1 of the present invention and the activated carbon of Comparative Example 1.

FIG. 4 is a comparison diagram of the desalination capacity of the DES-MOF and activated carbon prepared in Example 1 of the present invention.

FIG. 5 is a diagram of the capacitive desalination effect of the electrode cycle test of the present invention.

### DETAILED DESCRIPTION OF EMBODIMENTS

The technical solutions of the embodiments of the present invention will be described clearly and completely below in conjunction with the embodiments of the present invention, with reference to the preferred embodiments and the accompanying drawings. Obviously, the described embodiments are only some, but not all, of the embodiments of the present invention. All other embodiments obtained by those of ordinary skill in the art based on the embodiments of the present invention without creative effort shall fall within the protection scope of the present invention.

It should be noted that all professional terms used in the present invention are only for the purpose of describing specific embodiments, and are not intended to limit the protection scope of the present invention. Unless otherwise specified, the various raw materials, reagents, instruments, and equipment used in the following embodiments of the present invention can be purchased from the market or prepared by existing methods.

### Example 1

A method for preparing an iron-nickel bimetallic metal-organic framework activated carbon composite electrode material, comprising the following steps:

### (1) Preparation of Eutectic Solvent

Choline chloride is selected as a hydrogen bond acceptor and urea is selected as a hydrogen bond donor to prepare the eutectic solvent. 27.928 g of choline chloride and 24.024 g of urea are weighed, and choline chloride and urea are mixed at a molar ratio of 1:2, heated and stirred in an 80° C. water bath until a uniform and transparent liquid is obtained. Then, the eutectic solvent mixture is cooled to room temperature. Since the eutectic solvent has a low melting point, the eutectic solvent remains liquid even at room temperature.

### (2) Preparation of Iron-Nickel Bimetallic Composite Carbon Material

40 mL of the prepared eutectic solvent is added to a sealed glass bottle, and then 6 mL of deionized water (15% mass fraction) is added, and the mixture is ultrasonically mixed to obtain a DES-deionized water mixed solvent.

1.3516 g of ferric chloride hexahydrate and 3.564 g of nickel chloride hexahydrate are weighed and added to the mixed solvent, and after ultrasonic mixing for a period of time until fully dissolved, 2 g of pretreated activated carbon powder and 0.984 g of polyvinylpyrrolidone dispersant (20% of the mass of the metal salt) are added thereto, and the mixture is ultrasonicated for 30 min. Subsequently, 2.463 g of 2-methylimidazole is added to the above solution, and the mixture is ultrasonicated for 15 min to form a uniform mixed solution.

The mixed solution is transferred to a water bath and reacted at 60° C. for 12 h at a stirring rate of 200 rpm. After the reaction is completed, the glass bottle is taken out from the water bath, and then 10 mL of anhydrous ethanol is added and mixed with the reactant, and after centrifugation, the supernatant is poured out, the precipitate is collected, and washed and centrifuged 3 times each with deionized water and anhydrous ethanol, and then placed in a blast drying oven at 60° C. for 24 h, and naturally cooled to room temperature, taken out and ground to obtain an iron-nickel bimetallic metal-organic framework activated carbon composite material, which is recorded as DES-MOF.

### (3) Preparation of Electrode Slurry

The iron-nickel bimetallic metal-organic framework activated carbon composite material is used as an electrode active material, acetylene black is used as a conductive agent, and polyvinylidene fluoride is dissolved in N-methylpyrrolidone solution at a mass ratio of 2.5% as a binder. The three are placed in a sample bottle at a mass ratio of 8:1:1, and ground with a hand-held grinder for 10 min to mix them evenly, and magnetically stirred for 12 h to obtain a uniform electrode slurry.

The electrode slurry is uniformly coated on an 11 cm×11 cm titanium plate (effective coating area is 7 cm×7 cm) using a four-sided coating applicator, the electrode base thickness is 150 μm, and drying at 60° C. for 12 h yields the iron-nickel bimetallic metal-organic framework activated carbon composite electrode material.

### Example 2

A method for preparing an iron-nickel bimetallic metal-organic framework activated carbon composite electrode material, comprising the following steps:

### (1) Preparation of Eutectic Solvent

Choline chloride is selected as a hydrogen bond acceptor and urea is selected as a hydrogen bond donor to prepare the eutectic solvent. Choline chloride and urea are mixed at a molar ratio of 1:1.5, heated and stirred in an 80° C. water bath until a uniform and transparent liquid is obtained. Then, the eutectic solvent mixture is cooled to room temperature. Since the eutectic solvent has a low melting point, the eutectic solvent remains liquid even at room temperature.

### (2) Preparation of Iron-Nickel Bimetallic Composite Carbon Material

40 mL of the prepared eutectic solvent is added to a sealed glass bottle, and then 8 mL of deionized water (15% mass fraction) is added, and the mixture is ultrasonically mixed to obtain a DES-deionized water mixed solvent.

1.3516 g of ferric chloride hexahydrate and 3.564 g of nickel chloride hexahydrate are weighed and added to the mixed solvent, and after ultrasonic mixing for a period of time until fully dissolved, 1.5 g of pretreated activated carbon powder and 0.984 g of polyvinylpyrrolidone dispersant (15% of the mass of the metal salt) are added thereto, and the mixture is ultrasonicated for 30 min. Subsequently, 2.463 g of 2-methylimidazole is added to the above solution, and the mixture is ultrasonicated for 15 min to form a uniform mixed solution.

The mixed solution is transferred to a water bath and reacted at 70° C. for 11 h at a stirring rate of 200 rpm. After the reaction is completed, the glass bottle is taken out from the water bath, and then 10 mL of anhydrous ethanol is added and mixed with the reactant, and after centrifugation, the supernatant is poured out, the precipitate is collected, and washed and centrifuged 3 times each with deionized water and anhydrous ethanol, and then placed in a blast drying oven at 60° C. for 24 h, and naturally cooled to room temperature, taken out and ground to obtain an iron-nickel bimetallic metal-organic framework activated carbon composite material.

### (3) Preparation of Electrode Slurry

The iron-nickel bimetallic metal-organic framework activated carbon composite material is used as an electrode active material, acetylene black is used as a conductive agent, and polyvinylidene fluoride is dissolved in N-methylpyrrolidone solution at a mass ratio of 2.5% as a binder. The three are placed in a sample bottle at a mass ratio of 8:1:1, and ground with a hand-held grinder for 10 min to mix them evenly, and magnetically stirred for 12 h to obtain a uniform electrode slurry.

The electrode slurry is uniformly coated on an 11 cm×11 cm titanium plate (effective coating area is 7 cm×7 cm) using a four-sided coating applicator, the electrode base thickness is 150 μm, and drying at 60° C. for 12 h yields the iron-nickel bimetallic metal-organic framework activated carbon composite electrode material.

### Example 3

A method for preparing an iron-nickel bimetallic metal-organic framework activated carbon composite electrode material, comprising the following steps:

### (1) Preparation of Eutectic Solvent

Choline chloride is selected as a hydrogen bond acceptor and urea is selected as a hydrogen bond donor to prepare the eutectic solvent. Choline chloride and urea are mixed at a molar ratio of 1:2.5, heated and stirred in an 80° C. water bath until a uniform and transparent liquid is obtained. Then, the eutectic solvent mixture is cooled to room temperature. Since the eutectic solvent has a low melting point, the eutectic solvent remains liquid even at room temperature.

### (2) Preparation of Iron-Nickel Bimetallic Composite Carbon Material

40 mL of the prepared eutectic solvent is added to a sealed glass bottle, and then 10 mL of deionized water (15% mass fraction) is added, and the mixture is ultrasonically mixed to obtain a DES-deionized water mixed solvent.

1.3516 g of ferric chloride hexahydrate and 3.564 g of nickel chloride hexahydrate are weighed and added to the mixed solvent, and after ultrasonic mixing for a period of time until fully dissolved, 2.5 g of pretreated activated carbon powder and 0.984 g of polyvinylpyrrolidone dispersant (25% of the mass of the metal salt) are added thereto, and the mixture is ultrasonicated for 30 min. Subsequently, 2.463 g of 2-methylimidazole is added to the above solution, and the mixture is ultrasonicated for 15 min to form a uniform mixed solution.

The mixed solution is transferred to a water bath and reacted at 80° C. for 10 h at a stirring rate of 200 rpm. After the reaction is completed, the glass bottle is taken out from the water bath, and then 10 mL of anhydrous ethanol is added and mixed with the reactant, and after centrifugation, the supernatant is poured out, the precipitate is collected, and washed and centrifuged 3 times each with deionized water and anhydrous ethanol, and then placed in a blast drying oven at 60° C. for 24 h, and naturally cooled to room temperature, taken out and ground to obtain an iron-nickel bimetallic metal-organic framework activated carbon composite material.

### (3) Preparation of Electrode Slurry

The iron-nickel bimetallic metal-organic framework activated carbon composite material is used as an electrode active material, acetylene black is used as a conductive agent, and polyvinylidene fluoride is dissolved in N-methylpyrrolidone solution at a mass ratio of 2.5% as a binder. The three are placed in a sample bottle at a mass ratio of 8:1:1, and ground with a hand-held grinder for 10 min to mix them evenly, and magnetically stirred for 12 h to obtain a uniform electrode slurry.

The electrode slurry is uniformly coated on an 11 cm×11 cm titanium plate (effective coating area is 7 cm×7 cm) using a four-sided coating applicator, the electrode base thickness is 150 μm, and drying at 60° C. for 12 h yields the iron-nickel bimetallic metal-organic framework activated carbon composite electrode material.

### Comparative Example 1

The electrode active material in Example 1 is changed to activated carbon, and the other methods are the same, to obtain an activated carbon electrode.

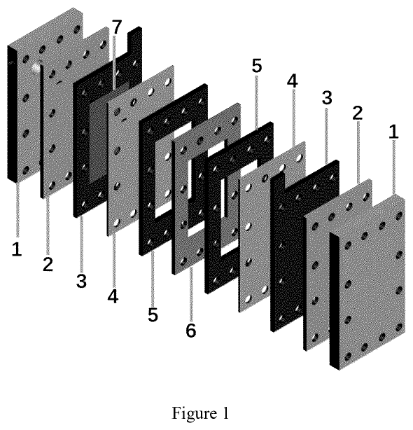

A schematic diagram of the CDI module structure is shown in FIG. 1, where 1 is a glass plate, 2 is a silicone gasket, 3 is a current collector, 4 is an ion exchange membrane, 5 is a hollow silicone gasket, 6 is a plastic gasket, and 7 is an electrode coating. A hybrid capacitive deionization module is selected to assemble an asymmetric electrode. The anode is a metal-organic framework activated carbon composite electrode, and the cathode is an activated carbon electrode. A cation exchange membrane and an anion exchange membrane are arranged in front of the anode and cathode plates. The CDI module is mainly composed of a glass plate 1, a silicone gasket 2, a current collector 3 coated with an electrode coating 7, an anion and cation exchange membrane 4, a hollow silicone gasket 5, and a plastic gasket 6. The glass plate 1 serves as an end plate of the electrode, and the electrode is fixed by screws. The glass plate 1 is provided with an inlet and an outlet to ensure water flow circulation in the electrode module. The inlet is at the bottom. After the liquid to be treated enters the CDI module, it passes through the water channel left by the plastic gasket 6 from bottom to top, and finally is discharged from the outlet at the top. The current collector 3 is made of a titanium plate, which functions to provide a coating substrate for the electrode material 7 and to transmit current. The silicone gasket 2 and the hollow silicone gasket 5 are respectively placed between the glass plate 1 and the current collector 3, and between the anion and cation exchange membrane 4 and the plastic gasket 6 to ensure good sealing performance of the electrode module. The plastic gasket 6 provides a water flow channel and prevents short circuits caused by contact between the two electrodes. The anion and cation exchange membrane 4 only allows cations and anions to pass through, mainly to prevent the occurrence of the co-ion effect.

The capacitive deionization system uses a circulating flow mode. The entire device is composed of a DC power supply, a CDI module, a solution to be treated, and a peristaltic pump. The DC power supply applies a DC voltage of 1.5 V to the two electrodes through the tabs of the current collector, and the peristaltic pump pumps the solution into the electrode module at a flow rate of 10 mL/min. After the solution flows through the two electrode coating areas, it flows out of the electrode module through the outlet and is pumped back into the original beaker by another peristaltic pump.

### Result Analysis

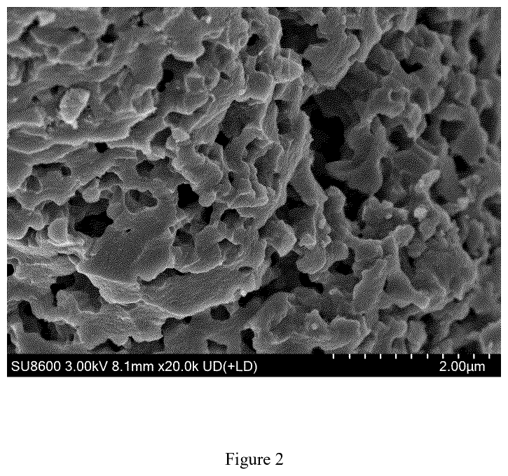

FIG. 2 is a SEM image of the DES-MOF powder prepared in Example 1. It can be observed from the scanning electron microscope image that a porous structure is formed on the surface of the DES-MOF material. This structure is beneficial to increasing the specific surface area of the material, thereby improving the ion adsorption capacity.

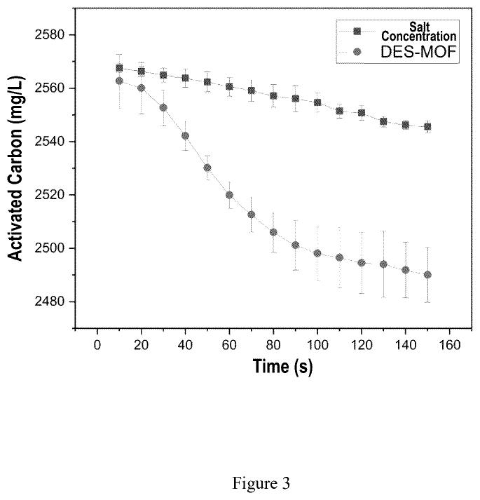

FIG. 3 is a comparison diagram of the decrease in salt solution concentration. As can be seen from the figure, in the same period of time (150 s), the salt concentration decrease value of the DES-MOF prepared in Example 1 is about 72.66 mg/L, and the salt concentration decrease value of activated carbon in Comparative Example 1 is about 22.01 mg/L. The salt concentration decrease value is increased by 230%, indicating that the DES-MOF removal efficiency is faster. This is mainly because the MOF material is loaded onto the activated carbon, which modifies the activated carbon and forms a porous structure, which is more conducive to adsorption.

The desalination performance of capacitive deionization technology is usually evaluated by the salt adsorption capacity (SAC). The magnitude of the salt adsorption capacity generally depends on experimental conditions such as the properties of the electrode coating, the operating voltage, and the type and concentration of the salt solution. The specific calculation formula is:

$$SAC = \frac{( {C}_{0} - {C}_{t} ) \times {V}_{s}}{m}$$

Where C₀ is the initial concentration of the sodium chloride solution, Cₜ is the concentration of the sodium chloride solution after t minutes of the desalination experiment, in mg/L, Vs is the volume of the sodium chloride solution, in mL, V's in the present invention is 60 mL, and m is the total mass of the coating on the two electrode sheets, in g.

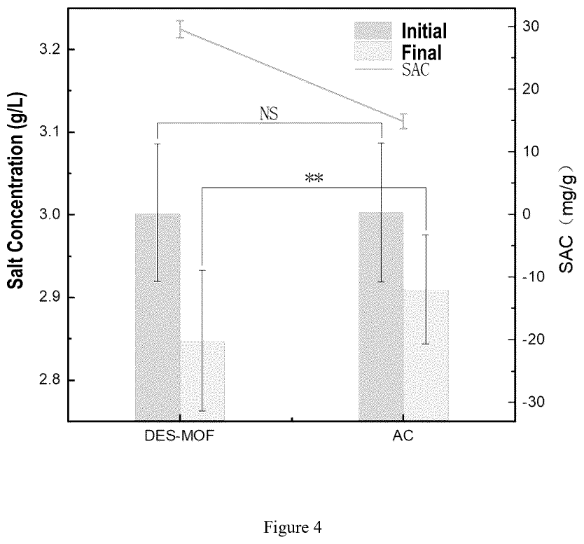

FIG. 4 is a comparison diagram of the salt adsorption capacity. As can be seen from the figure, under the same reaction conditions, the salt adsorption capacity of activated carbon is 14.18±0.31 mg/g, and the salt adsorption capacity of the DES-MOF prepared in Example 1 is 23.74±1.37 mg/g. The salt adsorption capacity of DES-MOF is increased by nearly 95.537% compared to the activated carbon electrode.

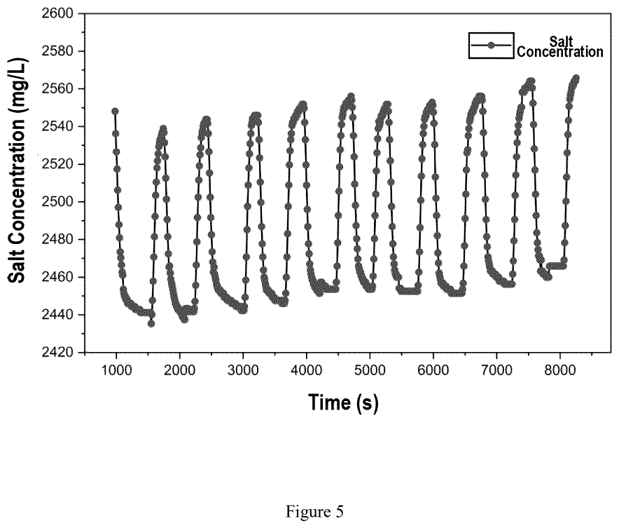

FIG. 5 is a diagram showing the capacitive deionization effect of the electrode cycle test prepared in Example 1. As shown in the figure, under the condition that the salt solution concentration is 2.5 g/L, after 10 capacitive deionization cycle tests on 60 mL of salt solution at a voltage of 1.5V, it can be seen that the salt adsorption capacity can still be maintained at 100 mg/L.

In summary, in the preparation process of the iron-nickel bimetallic organic framework activated carbon composite material of the present invention, a mixed solvent of a eutectic solvent and water is used as a ligand solution. During the synthesis process, the eutectic solvent not only acts as a solvent, but also as a structure-directing agent. Components in the eutectic solvent, such as chloride ions and choline ions, can coordinate with metal ions and act as templates or ligands to guide pore formation, regulate the pore structure of MOFs, and enhance their adsorption and separation performance. Chloride ions in the eutectic solvent or ammonia generated by decomposition can act as structure-directing agents, affecting the coordination mode of metal nodes, thereby regulating the pore size and porosity, and achieving efficient removal of salt ions in water.

It should be noted that when a numerical range is involved in the present invention, it should be understood that each of the two endpoints of each numerical range and any value between the two endpoints can be selected. Since the steps and methods used are the same as those in the examples, in order to prevent redundancy, the present invention describes preferred embodiments. Although the preferred embodiments of the present invention have been described, those skilled in the art can make other changes and modifications to these embodiments once they know the basic creative concept. Therefore, the appended claims are intended to be interpreted as including the preferred embodiments and all changes and modifications falling within the scope of the present invention.

Obviously, those skilled in the art can make various modifications and variations to the present invention without departing from the spirit and scope of the present invention. Thus, if these modifications and variations of the present invention fall within the scope of the claims of the present invention and their equivalents, the present invention is also intended to include these modifications and variations.

1. A method for preparing a bimetallic metal-organic framework electrode material based on a eutectic solvent, comprising the following steps:
mixing a eutectic solvent with water to obtain a mixed solvent;
using the mixed solvent containing the eutectic solvent and water as a ligand solution, adding a soluble iron salt and a soluble nickel salt to the mixed solvent, dissolving by sonication, then adding activated carbon powder and a dispersant, mixing by sonication, and then adding a 2-methylimidazole ligand to obtain an iron-nickel bimetallic metal-organic framework activated carbon composite precursor solution;
subjecting the iron-nickel bimetallic metal-organic framework activated carbon composite precursor solution to a water bath reaction, and performing post-treatment on the water bath reaction product to obtain an iron-nickel bimetallic metal-organic framework activated carbon composite material;
using the iron-nickel bimetallic metal-organic framework activated carbon composite material as an electrode active material, mixing with a conductive agent and a binder to obtain an electrode slurry, coating the electrode slurry on an electrode plate, and drying to obtain an iron-nickel bimetallic metal-organic framework activated carbon composite electrode material.

2. The method for preparing a bimetallic metal-organic framework electrode material based on a eutectic solvent according to claim 1, wherein the eutectic solvent is composed of a hydrogen bond acceptor and a hydrogen bond donor, the hydrogen bond acceptor is choline chloride, the hydrogen bond donor is urea, and the molar ratio of the hydrogen bond acceptor to the hydrogen bond donor is 1:1.5˜2.5.

3. The method for preparing a bimetallic metal-organic framework electrode material based on a eutectic solvent according to claim 1, wherein, in the mixed solvent, the volume ratio of the eutectic solvent to water is 20:3˜5.

4. The method for preparing a bimetallic metal-organic framework electrode material based on a eutectic solvent according to claim 1, characterized in that the ratio of the amount of iron element in the soluble iron salt, the nickel element in the soluble nickel salt to the mixed solvent is 1 mol:3 mol:46 mL˜50 mL.

5. The method for preparing a bimetallic metal-organic framework electrode material based on a eutectic solvent according to claim 1, wherein the ratio of the amount of activated carbon powder to the mixed solvent is 1.5 g˜2.5 g:46 mL˜50 mL, and the mass fraction of the dispersant in the soluble iron salt and the soluble nickel salt is 15%˜25%.

6. The method for preparing a bimetallic metal-organic framework electrode material based on a eutectic solvent according to claim 1, characterized in that the water bath reaction temperature is 60° C.˜80° C., and the reaction time is 10 h˜12 h.

7. The method for preparing a bimetallic metal-organic framework electrode material based on a eutectic solvent according to claim 1, wherein the mass ratio of the iron-nickel bimetallic metal-organic framework activated carbon composite material to the conductive agent and the binder is 80˜90:5˜10:5˜10.

8. A bimetallic metal-organic framework electrode material based on a eutectic solvent, prepared by the preparation method according to claim 1.

9. An application of the bimetallic metal-organic framework electrode material based on a eutectic solvent according to claim 8 in a hybrid capacitive deionization device, wherein the bimetallic metal-organic framework composite electrode material based on a eutectic solvent is applied to a hybrid capacitive deionization device to realize the removal of salt ions in water.

10. The application according to claim 9, wherein an asymmetric electrode is assembled by selecting a hybrid capacitive deionization module, the anode is the bimetallic metal-organic framework electrode material based on a eutectic solvent, the cathode is an activated carbon electrode, and a cation exchange membrane and an anion exchange membrane are arranged in front of the anode and cathode plates.
